(19) United States
(12) Patent Application Publication
(10) Pub. No.: US 2013/0330944 A1
(43) Pub. Date: Dec. 12, 2013

(54) SPRING-LOADED BLIND-MATE ELECTRICAL INTERCONNECT

(71) Applicant: ANDREW LLC, Hickory, NC (US)

(72) Inventors: John S. Rucki, New Providence, NJ (US); Jonathan H. Gelbstein, Green Brook, NJ (US); Julian R. Colapietro, Center Valley, PA (US)

(73) Assignee: ANDREW LLC, Hickory, NC (US)

(21) Appl. No.: 13/650,367

(22) Filed: Oct. 12, 2012

Related U.S. Application Data
(60) Provisional application No. 61/656,577, filed on Jun. 7, 2012.

(51) Int. Cl. H01R 12/71

(52) U.S. Cl. 439/81

(57) ABSTRACT

An electronic device, configured to be blindly mated with a printed circuit board, comprises a housing and at least one RF interconnect. The RF interconnect comprises an outer conductor, an insulator, and an inner conductor that function in a manner similar to the outer conductor, insulator, and inner conductor of a coaxial cable, respectively. The inner conductor comprises a spring-loaded electrical contact such as a POGO pin. An upper end of the outer conductor is electrically coupled to the housing and a lower end of the outer conductor is configured to electrically couple to a ground return path of the printed circuit board. In its normally extended position, the spring-loaded contact extends beyond the lower end of the outer conductor, and the outer conductor limits the compression distance of the spring-loaded contact.

### CROSS-REFERENCE TO RELATED APPLICATIONS

This application claims the benefit of the filing date of U.S. provisional application no. 61/656,577, filed on Jun. 7, 2012 as attorney docket no. 1052.103PROV, the teachings of all of which are incorporated herein by reference in their entirety.

### BACKGROUND

1. Field of the Invention

The present invention relates to electrical connections, and, more specifically but not exclusively, to connections for passing radio frequency (RF) signals and the like.

2. Description of the Related Art

An electronic device that uses radio frequency (RF) signals may need to pass RF signals to a printed circuit board. Conventionally, RF interconnects between electronic devices and printed circuit boards are made using an RF blind-mate connector pair or a combination of an RF connector and RF jumper cable. These conventional RF connector systems have several drawbacks. For instance, conventional connector systems are limited in the radial and axial misalignment that can exist when making a RF connection. This is especially true in smaller connector systems such as sub-miniature version A (SMA) connectors, sub-miniature push-on (SMP) connectors, and micro-coax (MCX) RF connectors.

Radial misalignment exists when the axis of the connector on the electric device is not perfectly aligned with the axis of the connector on the printed circuit board. If radial misalignment between a conventional connector mounted on the electronic device and a conventional connector mounted on a printed circuit board is too great, then the electronic device will not electrically couple to the printed circuit board properly. Axial misalignment exists when the mating surfaces of the electrical device and printed circuit board are closer or farther apart than the designed nominal distance. Thus, if axial misalignment between a conventional connector mounted on the electronic device and a conventional connector mounted on the printed circuit board is too great, then the electronic device will not electrically couple to the printed circuit board properly.

Aside from misalignment issues, conventional connector systems are also relatively expensive. Blind-mate RF connector systems require two connectors: one mounted on the printed circuit board and one mounted on the electronic device. The cost of the connector pair typically adds significant cost to the overall system, particularly when multiple RF interconnections are being made.

### SUMMARY

In one embodiment, the present invention is an electronic device comprising a housing and at least one electrical interconnect. The at least one electrical interconnect is configured to mate with a printed circuit board and comprises an outer conductor and an inner conductor within the outer conductor. The outer conductor comprises a first end that is electrically coupled to the housing and a second end that extends away from an external surface of the housing. The second end is configured to electrically couple to a return path on the printed circuit board. The inner conductor comprises a spring-loaded electrical contact configured to electrically couple to a trace on the printed circuit board. Further, the outer conductor is configured to limit a compression distance of the spring-loaded electrical contact.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 shows a cross-sectional view of an electronic device according to one embodiment of the disclosure;

FIG. 2 shows a cross-sectional view of a radio frequency (RF) interconnect mated with a printed circuit board;

FIG. 3 shows a cross-sectional perspective view of a portion of the RF interconnect in FIG. 2 mated with a trace on a printed circuit board;

FIG. 4 shows a perspective view of a portion of the bottom of the electronic device in FIG. 1; and

FIG. 5 shows a cross-sectional perspective view of a portion of an RF interconnect mated with a printed circuit board according to an alternative embodiment of the disclosure.

### DETAILED DESCRIPTION

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

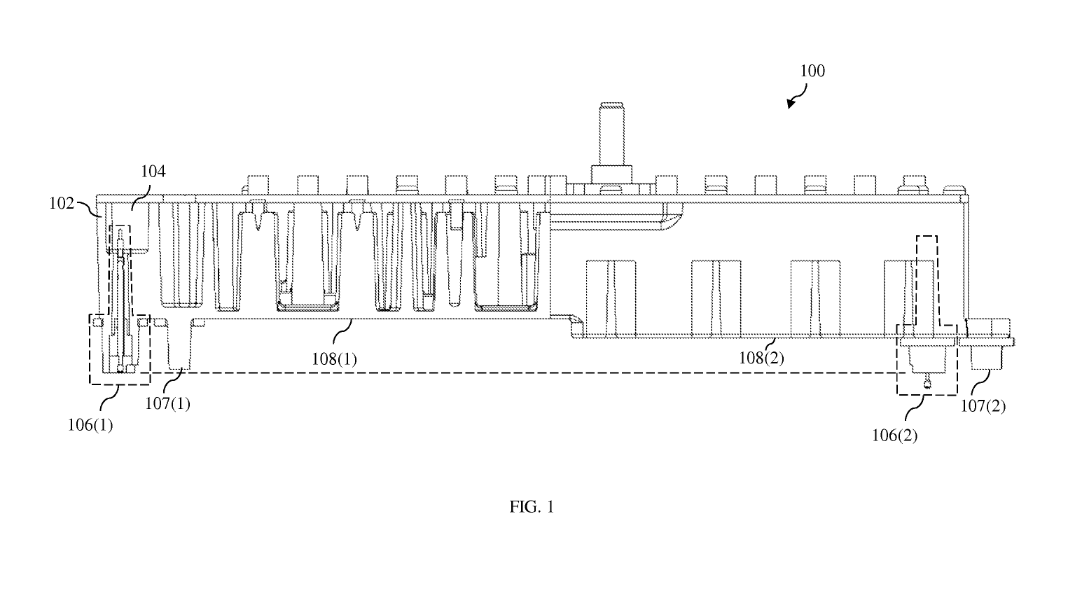

FIG. 1 shows a cross-sectional view of an electronic device 100 according to one embodiment of the disclosure. In this embodiment, electronic device 100 is an active antenna component. However, alternative embodiments of the disclosure may be implemented using any suitable electronic device that processes communications signals.

Electronic device 100 has (i) a housing 102 with one or more cavities 104 formed therein, (ii) circuitry (not shown) for processing RF signals situated in the one or more cavities 104, (iii) a plurality of mounting posts, of which two (i.e., 107(1) and 107(2)) are shown FIG. 1, and (iv) a plurality of interconnects, of which two (i.e., 106(1) and 106(2)) are shown in FIG. 1. Note that, as used herein, the term RF refers to any frequency used to communicate signals and is not limited to any specific frequency band. Interconnect 106(1) extends from a first bottom surface 108(1) of housing 102 and interconnect 106(2) extends from a second bottom surface 108(2) of housing 102.

The interconnects (an example of which is described in further detail below) are configured such that electronic device 100 may be blindly mated with a printed circuit board (not shown). Each interconnect permits some axial and radial misalignment. As a result, electronic device 100 may be successfully mated with a printed circuit board in spite of mechanical tolerance uncertainty or other misalignment issues that might occur when electronic device 100 is blindly mated with a printed circuit board. Electronic device 100 may then be secured to the printed circuit board by (i) passing a male threaded fastener, such as a screw or bolt, through each of mounting post 107(1) and 107(2) and (ii) securing the male threaded fastener to a female threaded fastener mounted on or underneath the printed circuit board. Note that, in this embodiment, interconnects 106(1) and 106(2) are configured to mate with the same plane of a printed circuit board as indicated by the dashed line between interconnects 106(1) and 106(2). However, in alternative embodiments, the interconnects may be configured to mate with different planes of a printed circuit board or different printed circuit boards residing on different planes.

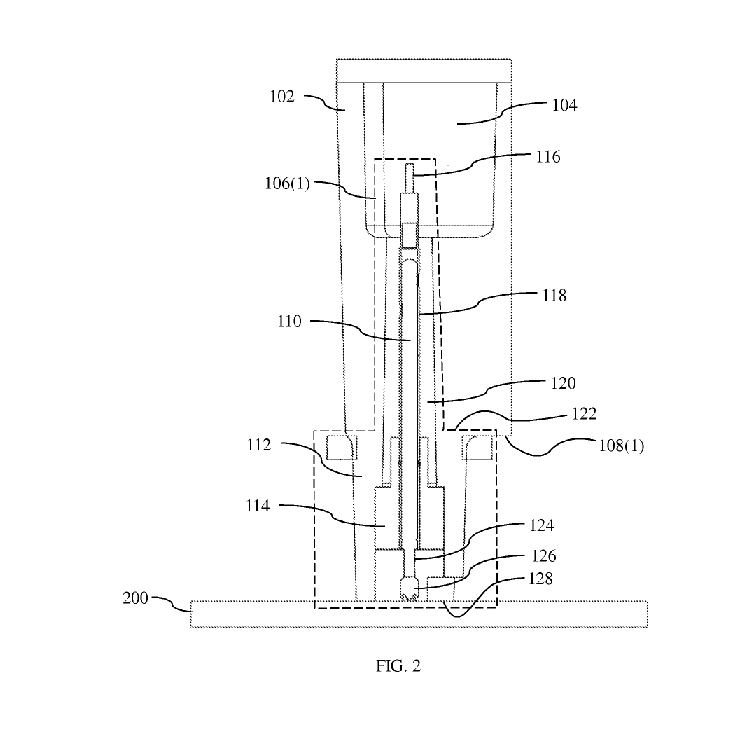

FIG. 2 shows a cross-sectional view of an RF interconnect 106(1) mated with a printed circuit board 200 according to one embodiment of the disclosure. Note that a similar RF interconnect may be used to implement each of the RF interconnects of housing 100 such as 106(2) in FIG. 1. RF interconnect 106(1) comprises an inner conductor 110, an outer conductor 112, and an insulator 114 separating inner conductor 110 from outer conductor 112. In at least some embodiments of the disclosure, inner conductor 110, outer conductor 112, and insulator 114 are all sized to achieve 50-ohm impedance. Outer conductor 112 has a tubular shape with (i) a bottom end 128 that is configured to contact a ground return path of printed circuit board 200 as discussed further below and (ii) an upper end 122 that is electrically coupled to a bottom surface 108(1) of housing 102 of electronic device 100.

In some embodiments of the disclosure, outer conductor 112 is integral to housing 102, meaning that outer conductor 112 and housing 102 are formed from a single piece of conducting material. For example, outer conductor 112 and housing 102 may be die-cast into a single integral piece. In other embodiments of the disclosure, outer conductor 112 may be a separate piece from housing 102 and may be attached to housing 102 using any suitable attachment method for providing mechanical and electrical connection. For example, outer conductor 112 may be welded to housing 102, threaded onto housing 102, press-fit onto housing 102, etc. Note that, forming outer conductor 112 and housing 102 together as a single integral piece may be less costly than forming outer conductor 112 and housing 102 separately and attaching the separate pieces together.

To accommodate inner conductor 110, a hole 120 is formed in outer conductor 112 and housing 102. Hole 120 extends from bottom end 128 of outer conductor 112 into cavity 104 formed in housing 102 where the RF processing circuitry is housed. Inner conductor 110, which extends from cavity 104 through hole 120 to bottom end 128 of outer conductor 112, comprises a spring-loaded pin 124 within a casing 118. A contact tip 126 is positioned on the bottom end of spring-loaded pin 124 to mate with a trace (not shown) on printed circuit board 200. Note that, in this embodiment, inner conductor 110 is implemented using a spring-loaded contact often referred to as a POGO pin. In alternative embodiments of the disclosure, inner conductor 110 may be implemented with other spring-loaded contacts, including those that do not use pins.

Normally, contact tip 126 extends beyond bottom end 128 of outer conductor 112 in a manner similar to that shown by interconnect 106(2) of FIG. 1. However, when pressure is applied to the bottom of contact tip 126, spring-loaded pin 124 retracts within casing 118 causing contact tip 126 to retract within outer conductor 112. In other words, contact tip 126 retracts and extends responsively to the pressure applied by the printed circuit board to ensure proper electrical coupling. The use of spring-loaded pin 124 permits interconnect 106(1) to withstand a greater amount of axial misalignment than comparable conventional connection systems and still make proper contact with the printed circuit board for electrical coupling.

When interconnect 106(1) is mated with printed circuit board 200, the bottom end 128 of outer conductor 112 acts as a hard stop against printed circuit board 200 and limits the compression distance of spring-loaded pin 124 (i.e., the distance that contact tip 126 retracts into outer conductor 112). In the embodiment in FIG. 2, contact tip 126 retracts until the bottom surface of contact tip 126 is substantially co-planar with bottom surface 128 of outer conductor 112. However, according to alternative embodiments of the disclosure, the bottom surface of contact tip 126 and the bottom surface of outer conductor 112 need not be co-planar. For example, the trace on the printed circuit board could be elevated above the upper surface of the printed circuit board such that the bottom surface of contact tip 126 is above the bottom surface of outer conductor 112. Alternatively, the trace could be sunken below the upper surface of the printed circuit board such that the bottom surface of contact tip 126 is below the bottom surface of outer conductor 112.

The bottom surface 128 of outer conductor 112 creates low impedance electrical contact between outer conductor 112 and the ground circuit on circuit board 200. This forms the return path for currents flowing up or down center conductor 110. The inside diameter of outer conductor 112 is set appropriately to create a controlled impedance path for the center conductor. In some embodiments of the present disclosure, interconnect 106(1) is designed for a 50 Ohm impedance. In alternative embodiments, interconnect 106(1) is designed for an impedance other than 50 Ohms.

Inside cavity 104 of electronic device 100, RF processing circuitry (not shown) is connected to the upper end 116 of inner conductor 110. RF processing can be, for example, another printed circuit board. In some embodiments of the disclosure, the RF processing circuitry is directly connected to upper end 116 without using cabling. For instance, the RF processing circuitry may be connected to upper end 116 using soldering or by press-fitting the RF processing circuitry onto upper end 116. This eliminates the cost associated with using separable connectors and cabling. However, in alternative embodiments of the disclosure, the RF processing circuitry may be connected to upper end 116 using separable connectors and cabling. Note that the ground return path travels from printed circuit board 200 through outer conductor 112 and terminates at housing 102. Therefore, there is no need to have a ground return connection to the RF processing circuitry within cavity 104. Eliminating this ground return connection eliminates a potential source of failure within electronic device 100.

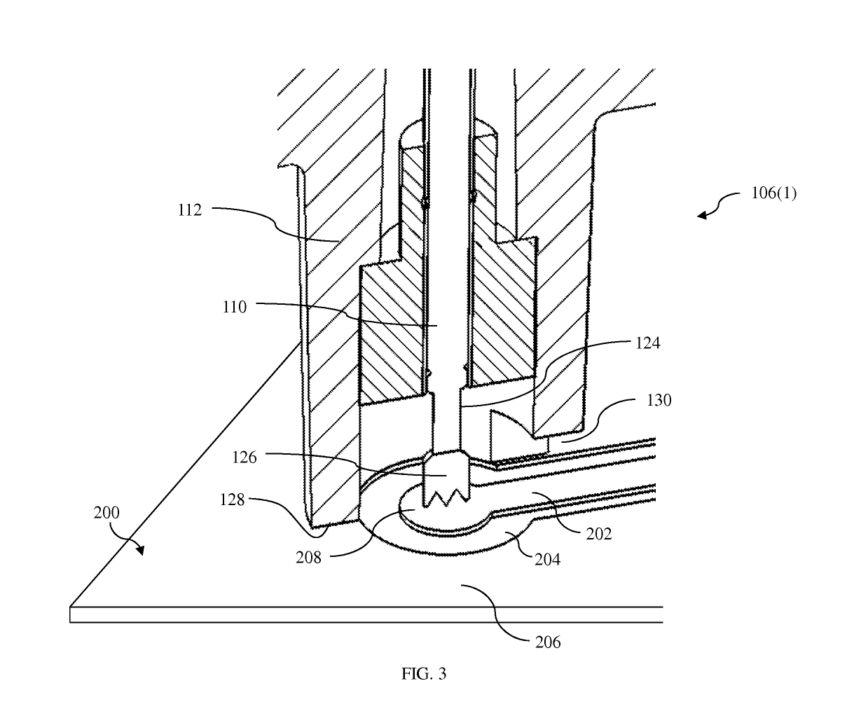

FIG. 3 shows a cross-sectional perspective view of a portion of interconnect 106(1) mated with a trace 202 on printed circuit board 200. Trace 202 runs along the upper surface of printed circuit board 200 and serves as a conductive pathway that communicates signals between tip 126 and other electronic components attached to printed circuit board 200. Trace 202 is etched onto a non-conductive substrate, a portion of which is exposed around trace 202 to form an insulating gap 204. Insulating gap 204 prevents electrical coupling between trace 202 and a conductive layer 206 formed on the upper surface of printed circuit board 200 that serves as ground return path. Together, trace 202, insulating gap 204, and ground return path 206 of printed circuit board 200 function in a manner similar to that of a coaxial cable, with trace 202 functioning as the inner conductor of the cable, insulating gap 204 functioning as the insulator surrounding the inner conductor of the cable, and ground return path 206 functioning as the outer conductor of the cable.

The controlled impedance path created by trace 202, insulating gap 204, and ground return path 206 is continued through the construction of outer conductor 112 and inner conductor 110. The signal on trace 202 flows towards (or from) tip 126 and up (or down) center conductor 110. The corresponding return signal flows along the inside surface of outer conductor 112, through the electrical contact formed by surface 128 resting against conductive layer 206.

Trace 202 traverses the upper surface of printed circuit board 200 and terminates at contact pad 208 (or begins at contact pad 208, depending on which direction the signal is traveling). Electrical coupling between trace 202 and spring-loaded pin 124 results from tip 126 contacting contact pad 208. Contact pad 208 has a circular shape having a diameter that is larger than the width of the rest of trace 202 and larger than the diameter of tip 126, such that contact tip 126 is able to electrically couple with trace 202 when radial misalignment exists between contact tip 126 and contact pad 208. Radial misalignment exists between contact tip 126 and contact pad 208 when the axis of contact tip 126 is not perfectly aligned with the center of contact pad 208. The amount of radial misalignment that can be accommodated may be increased or decreased by increasing or decreasing the diameter of contact pad 208. Note that, in alternative embodiments of the disclosure, contact pad 208 may have a shape other than a circle.

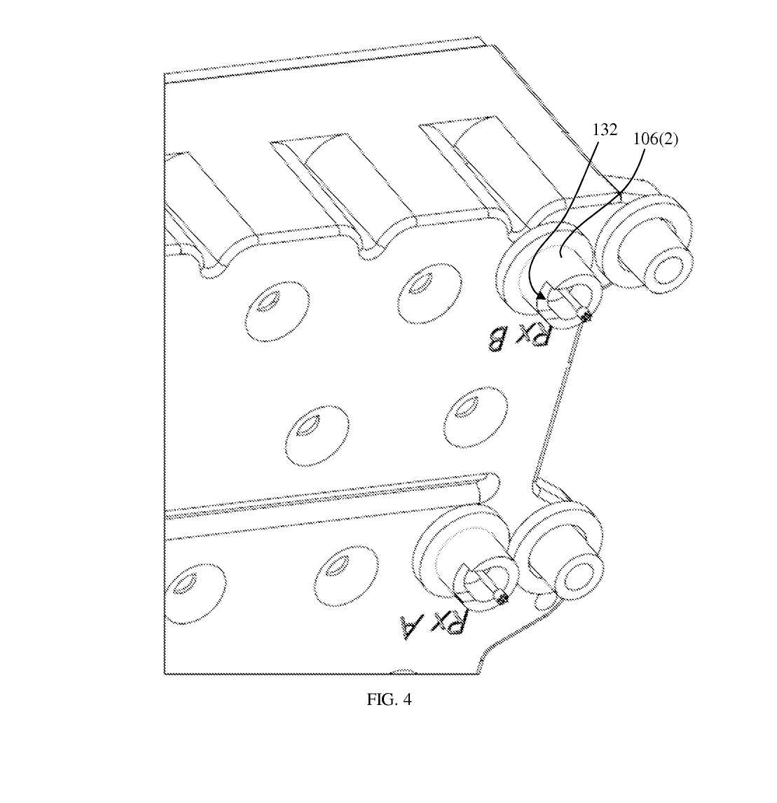

To prevent outer conductor 112 from contacting trace 202, a notch 130 is formed on the bottom surface 128 of outer conductor 112. An example of such a notch 130 may be seen in FIG. 4, which shows a perspective view of a portion of the bottom of electronic device 100 of FIG. 1. In particular, FIG. 4 shows the bottom of interconnect 106(2), which has a notch 132 similar to that of notch 130 of interconnect 106(1).

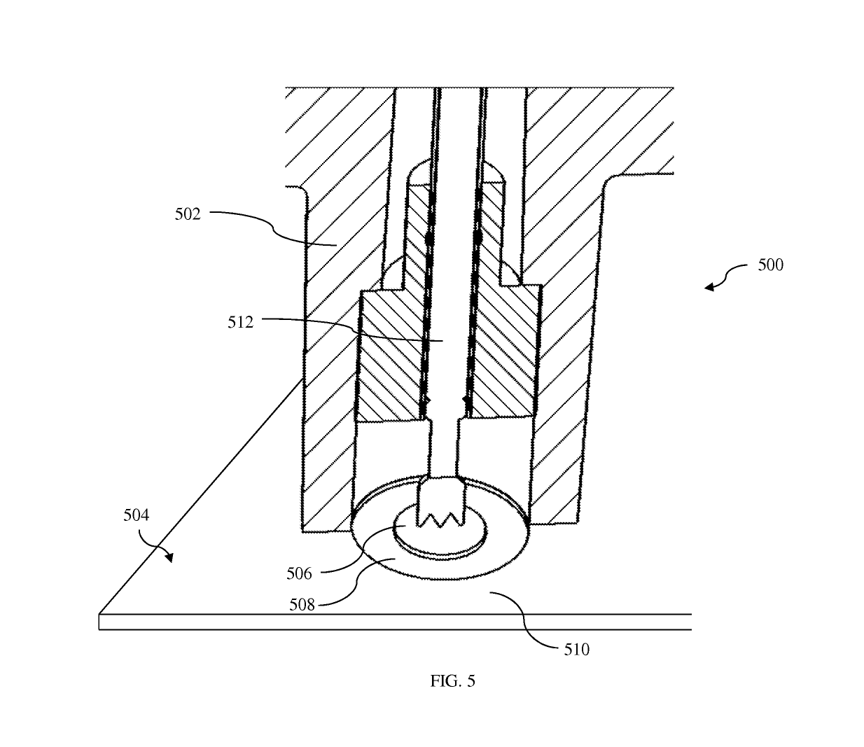

FIG. 5 shows a cross-sectional perspective view of a portion of an RF interconnect 500 mated with a printed circuit board 504 according to an alternative embodiment of the disclosure. RF interconnect 500 may be used to implement one or more RF interconnects such as 106(1) or 106(2) of FIG. 1. In this embodiment, a contact pad 506 is positioned on the upper surface of printed circuit board 504. An insulating gap 508 prevents electrical coupling between contact pad 506 and a conductive layer 510 formed on the upper surface of printed circuit board 200 that serves as ground return path. The contact pad 506 is connected to lower level traces inside the multi-layer circuit board by way of a plated through hole commonly referred to as a circuit board ‘via’. The electrical signal passes to (or from) the center conductor 512, to the pad 506, up (or down) on the plated through hole, and from (or to) a lower level trace connected to the plated through hole.

In general, contact pad 506, insulating gap 508, and ground return path 510 of printed circuit board 504 function in a manner similar to that of contact pad 208, insulating gap 204, and ground return path 206 of printed circuit board 200, respectively. The only difference between printed circuit board 504 and printed circuit board 200 is that much of the trace, aside from the contact pads such as contact pad 208, is buried under the upper surface of printed circuit board 504, and consequently is not shown. Since the trace is buried, outer conductor 502 does not need a notch similar to notch 130 of FIG. 2.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. An electronic device comprising:
a housing; and
at least one electrical interconnect configured to mate with a printed circuit board, the at least one electrical interconnect comprising:
an outer conductor comprising:
a first end that is electrically coupled to the housing; and
a second end that extends away from an external surface of the housing and is configured to electrically couple to a return path on the printed circuit board; and
an inner conductor within the outer conductor, the inner conductor comprising a spring-loaded electrical contact configured to electrically couple to a trace on the printed circuit board, wherein the outer conductor is configured to limit a compression distance of the spring-loaded electrical contact.

2. The electronic device of claim 1, wherein the outer conductor is integral to the housing.

3. The electronic device of claim 1, further comprising RF processing circuitry.

4. The electronic device of claim 3, wherein the RF processing circuitry is configured to electrically couple to the inner conductor but not the outer conductor.

5. The electronic device of claim 1, wherein the spring-loaded electrical contact comprises a POGO pin.

6. The electronic device of claim 1, wherein a bottom surface of the outer conductor has a cutout formed therein.

7. The electronic device of claim 6, wherein, when the electronic device is mated with a printed circuit board having a trace, the trace falls within the cutout and the cutout prevents electrical coupling between the outer conductor and the trace.

8. The electronic device of claim 1, wherein:
in a fully extended position, the inner conductor extends beyond a bottom surface of the outer conductor;
in a retracted position, the inner conductor is substantially co-planar with a bottom surface of the outer conductor.

9. The electronic device of claim 1, wherein an upper end of the spring-loaded contact is configured to mate to circuitry in the housing without cabling.

10. The electronic device of claim 1, further comprising the printed circuit board.
